(19) United States
(12) Patent Application Publication
(10) Pub. No.: US 2017/0072329 A1
(43) Pub. Date: Mar. 16, 2017

(54) A Dynamic Notification System Via A Product

(71) Applicant: SEEBO INTERACTIVE LTD., Tel Aviv (IL)

(72) Inventors: Lior Akavia, Tel Aviv (IL); Liran Akavia, Tel Aviv (IL); Yarden Hod, Tel Aviv (IL); Mordechi Moti Lavian, Tel Aviv (IL)

(73) Assignee: Seebo Interactive, Ltd., Tel Aviv (IL)

(21) Appl. No.: 15/125,034

(22) PCT Filed: Mar. 9, 2015
(86) PCT No.: PCT/IL2015/050247

§ 371 Date: Sep. 9, 2016

Related U.S. Application Data
(60) Provisional application No. 61/950,153, filed on Mar. 9, 2014.

(51) Int. Cl. A63H 3/28; H04W 4/00; H04L 29/08

(52) U.S. Cl. CPC A63H 3/28; H04L 67/125; H04W 4/008; A63H 2200/00

(57) ABSTRACT

The invention is directed to a dynamic notification system configured to allow a product to send one or more notifications to a user in a dynamic and programmable manner, without having a constant connection to a smart device, and without being constantly in an operation mode, said system comprising: a product configured to be synchronized with a smart device of said user for obtaining at least one notification to be executed by at least one output element comprised in said product, wherein said product is configured to power itself on at a time point a notification should be executed, and to turn itself off upon completing to execute said notification instructions until another notification time point arrives to be executed, so as to consume minimal energy between executions of subsequent notifications; and a smart device comprising a dedicated software configured to allow recognition and connectivity of the smart device with said product so as to transmit notifications to said product to be executed according to a predefined manner.

### FIELD OF THE INVENTION

This invention is in the field of connected products in general, and more particular it is directed to a system and method for transmission and activation of dynamic and changeable notifications in a physical product without wasting energy.

### TECHNOLOGICAL FIELD AND BACKGROUND

Physical toys that contain electronic components are traditionally named ‘electronic toys’ and are commonly seen in the average household of the 21st century. In the last few years, of connecting these electronic toys to software applications and/or to the internet is emerging. This trend generally named the “Internet of things” and describes the general tendency to connect various consumer products to the internet and to smart devices of the user (http://en.wikipedia.org/wiki/Internet_of_Things).

In today's world, most people carry their smart phones and other smart devices with them everywhere they go. Thus, information about schedule, notifications, timing and alerts have become highly accessible. More and more users set their alarm clock through the smart device, and use sophisticated calendars as a diary in order to remember upcoming events. For example, users may set a notification in their smart device calendar on their anniversary day, birthday dates of family and friends, meeting at work, events at school, turns to doctors, and the like. They may further set a more complex message and a sound, such as “Remember to buy milk” with a customized music or sound. Furthermore, some applications send notifications to their users regarding different subjects, for example, Facebook application is sending a push notifications to users when they receive a message or when a friend's birthday is approaching, and even game applications send notifications to users to motivate them to continue playing, for example: “remember to water the plants in your garden!”.

An example of a smart home use product, is the Samsung™ refrigeration that can send notifications to a user about missing ingredients inside the refrigerator, and helps the owner to manage his stock: http://www.samsung.com/us/appliances/refrigerators/RF4289HARS/XAA. In such case, the product is directly connected to the internet (for example by connecting to the internet home).

Other products may be indirectly connected to the internet, and connect through a mediating device, such as smart device (smartphones, tablets, smart TVs and the like), that is connected to the internet. An example of such product that connects to the internet indirectly is the Furby toy (http://www.hasbro.com/furby/en_US/#panel_talk) by Hasbro® that connects to the smart device through encoded sound frequencies.

In both cases, the connection to the internet (directly or indirectly) requires significant electricity consumption, a limit that becomes major when the product is battery-operated, as the electricity consumption require frequent change of batteries, which is undesirable and cumbersome.

Thus, there is a need in the modern reality for economic and low consumption solution for connecting products to the internet, for example in order to get notifications and alerts to a user directly from his personal email/calendar.

The present invention is aimed to provide an efficient solution for providing notifications and alerts to a user in cases in which the smart device is not always available. The notifications in accordance with the invention are provided to a user indirectly by one or more peripheral products configured to be connected from time to time to a smart device to obtain new notifications, and to output each notification to the user according to a notification table even when they are not connected to the smart device. In addition, the product is configured to power itself on and off according to the notifications schedule to further save energy.

The following references may be relevant to the subject matter of the invention: US Patent Application No. 2013185786, US Patent Application No. 2001021669, US Patent Application No. 2013191671, International application No. WO/0169830, and U.S. Pat. No. 8,545,283.

### SUMMARY OF THE INVENTION

The subject matter described herein is directed to novel dynamic notification system configured to allows a product to send one or more notifications to a user in a dynamic and programmable manner, without having a constant connection to a smart device, and without being constantly in an operation mode, said system comprising: (a) a product configured to be synchronized with a smart device of said user for obtaining at least one notification to be executed by at least one output element comprised in said product, wherein said product is configured to power itself on at a time point a notification should be executed, and to turn itself off upon completing to execute said notification instructions until another notification time point arrives to be executed, so as to consume minimal energy between executions of subsequent notifications; and (b) a smart device comprising a dedicated software configured to allow recognition and connectivity of the smart device with said product so as to transmit notifications to said product to be executed according to a pre-defined manner.

The product may comprise at least:
(a) A firmware configured to control and manage a memory unit according to time intervals counted by a time counting module so as to allow said product to turn itself on at predefined time points and execute listed notifications that are stored in said memory unit;
(b) A memory unit configured to allow storage of said notifications with timing and content;
(c) A time counting module configured to count time intervals so as to allow the product to power on at a certain point in time, activate the notification and power itself off;
(d) A micro control unit having a communication module configured to allow the product to synchronize with said smart device and to control the operation of at least one output element;
(e) At least one output element configured to allow execution of said notifications instructions; and
(f) A power source.

In some embodiments, the product is configured to be powered on and synchronized with said smart device in at least one of the following situations: (a) every predefined time period; (b) upon accumulation of a predefined number of new notifications in the smart device; (c) upon performance of manual synchronization of the product by the user. The predefined period of time may be set by the user. Alternatively the period of time may be set automatically according to the user's usage pattern determined by analytical analysis performed by the smart device or a remote server connected to the smart device.

The output element may be for example but not limited to, LEDs, buzzers, speaker, mechanic elements, vibrations, and screens.

The product may be capable of executing the notification's instructions saved in the memory unit while being connected or non-connected to the smart device.

The notification may be a repeated notification configured to be executed periodically by said product.

The dynamic notification system according to the above may further comprise an input element configure to allow a user to follow instructions of a notification so as to provide the product an input for activating an output reaction by the product.

In some embodiments of the invention, the smart device may further be connected to a cloud server. The cloud server may further allow the smart device to deliver to said product at least one notification obtained from a smart device of another user.

Optionally, the cloud server may further allow a user to send notification to said product from a remote location by using additional smart device of said user.

The smart device used in the dynamic notification provided herein may be for example a smart phone, tablet, phablet, smart television, laptop, smart wearable device, and personal computer.

The notification may be a set of actions that are being executed by said product in a sequence according to the predefined instructions received from the smart device by one or more output elements.

The present invention is further directed to a product configured to be synchronized with a smart device of a user for obtaining at least one notification to be executed by at least one output element comprised in said product, wherein said product is configured to power itself on at a time point a notification should be executed, and to turn itself off upon completing to execute said notification instructions until another notification time point arrives to be executed, so as to consume minimal energy between executions of subsequent notifications. The product preferably comprises at least a firmware configured to control and manage a memory unit according to time intervals counted by a clock module so as to allow said product to turn itself on at predefined time points and execute listed notifications that are stored in said memory unit; A memory unit configured to allow storage of said notifications with timing and content; A time counting module configured to count time intervals so as to allow the product to power on at a certain point in time, activate the notification and power itself off; A micro control unit having a communication module configured to allow the product to synchronize with said smart device and to control the operation of at least one output element; At least one output element configured to allow execution of said notifications instructions; and a power source.

The product is preferably configured to be powered on and synchronized with said smart device in at least one of the following situations: (a) every predefined time period; (b) upon accumulation of a predefined number of new notifications in the smart device; (c) upon performance of manual synchronization of the product by the user.

The product may be capable of executing said notification's instructions saved in said memory unit while being connected or non-connected to the smart device.

The notification may be a repeated notification configured to be executed periodically by said product. Additionally or alternatively, the notification may be a set of actions that are being executed by said product in a sequence according to the predefined instructions received from the smart device by one or more output elements.

The product according to the above may further comprise an input element configure to allow a user to follow instructions of a notification so as to provide the product an input for activating an output reaction by the device. in some embodiments, the input element is configured to allow a manual or automatic monitoring on the timing of the notification, delay it or prevent it.

### BRIEF DESCRIPTION OF THE DRAWINGS

Examples illustrative of variations of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. The figures presented are in the form of schematic illustrations and, as such, certain elements may be drawn greatly simplified or not-to-scale, for illustrative clarity. The figures are not intended to be production drawings.

The figures (Figs.) are listed below.

FIG. 1 is a schematic illustration of an example of a dynamic notification system for transmission and activation of notifications into a product without wasting energy.

FIG. 2 is a schematic diagram of another example of a dynamic notification system for dynamic transmission and activation of notifications from a server into a product without wasting energy.

FIG. 3 is a sequence diagram illustrating a main use case of the system illustrated in FIG. 1.

FIG. 4 is a sequence diagram illustrating a main use case of the system illustrated in FIG. 2.

### DESCRIPTION OF EMBODIMENT OF THE INVENTION

The subject matter disclosed herein is directed to a system that allows a product to send alerts and notifications to a user in a dynamic and programmable manner, without having a constant connection to the internet and/or to a smart device, and without being constantly in an operation (turn-on) mode in order to avoid energy waste.

The present invention is useful for cases in which the smart device is not always available to the user. For example, children is a population that usually have limited time with smart devices, and in many cases they don't own their own device. Thus, they may need a simple device to save alerts and notifications, such as toys, alarm clocks, sport accessories and the like. Elderly people are another example of population, who in many cases have smart devices but find it difficult to operate by themselves and may make use of a system that provides them with dynamic notifications by a simpler product. Another population that cannot be constantly connected to smart devices is of people that work in places which does not allow the usage of smart devices during work in specific areas, either from confidential or safety reasons.

All the above cases are examples to populations that do not hold smart device in their hands on a regular basis, and thus do not hold a sophisticated system for time managing, calendar and alerts.

The present invention is aimed to provide solutions for such none favorable states based on a consumer product configured to be synchronized with a smart device from time to time for obtaining updated notifications and to execute the notifications obtained from the smart device, each notification according to its rime and content by at least one output element such as but not limited to LED, lights, speakers, buzzers, vibration, mechanic elements and screens. The notifying product is able to communicate with a smart device by a communication module, which allows the product to communicate with at least one smart device of a user having a dedicated software installed on it, wherein the communication between the notifying product and the at least one smart device of the same user may be either by wired connection or by a wireless connection, such as but not limited to Bluetooth, BLE, NFC, and Wi-Fi connection.

As long as the notifying product is within the receiving range of the smart device, the product is capable of communicating with it through the communication module, and the smart device may send instructions to the product, to activate for example, the output elements that are placed on the product, thus creating an immediate reaction. In this state of connection, the user may use the smart device and the product simultaneously. The smart device may further load, automatically or manually, additional instructions to the product for example, to operate in a certain manner while not being connected to the smart device in a specific time point. For example, the smart device may instruct the product to play certain music and set it to start playing it three hours after receiving the notification. Once the smart device gets out of range, the product will operate the notifications automatically, and will activate the desired music three hours after the instruction was given, even if the smart device is out of range at the time of playing the music.

In accordance with embodiments of the invention the dynamic notification system may include submission of one or more notifications at one synchronization cycle between the smart device and the product, in a specific order or randomly, in a repeated manner or by a single notification each time, with a predefined and unique output or with a generic output. The dynamic notification system of the invention is configured to allow a smart device to update a specific product with a set of notifications from time to time in order to allow a dynamic downloading of content and notifications in a unique and complex manner with respect to other notification systems known in the art, wherein the execution of the notification by the product may occur while the product in not connected with the smart device on in its vicinity.

The smart device may for example, instruct the product to play a certain song every day on 2:00 pm, or to sync with the user's calendar and produce the right notifications for his daily events. In the last example, the user will be required to sync the product with the smart device once in a while, in order to keep updating the notifications according to his calendar. The user may further link the product with his Facebook alerts, game applications, online information such as his sports team's season schedule and similar available alerting systems.

The product comprises a memory component which allows it to save multiple notification events and output instructions. For example, a user may download his favorite basketball team's game schedule into a basketball player toy, or a decorative basketball positioned in his room containing for example the following output sensors: red LED, green LED and a speaker. In this example, when the smart device syncs with the ball, the ball downloads the team's schedule with a suitable voice over for each game that reads the teams participating in the game, the hour and the channel of broadcast. The user may set an alert to start an hour before the game. The ball will save the game along with the specified voice over sound, for example: “Chicago Bulls vs Miami Hit at 22:00 Channel 5! Get ready”. The alert may further include the team's official song, different sound effects and more. When the broadcast time arrives, the toy will operate the alarm with the specified sound. The LEDs may further indicate if this is an away game or a home game, wherein a green light may indicate a home game, and a red light may indicate away game. The user may set the general definitions, and the updates may be downloaded to the product automatically each time that the user connects the software app to the product.

Another example for implementing the subject matter of the invention may be demonstrated by a smart mini-watch that a child may carry around. In this example, the watch may be used to show the time and set alarms. The watch may comprise a speaker and a screen, which presents the hour. When the child arrives home, the watch may sync automatically to a dedicated application in one of the smart devices at home, which allows other users to send him notifications either by the smart device directly or by a remote cloud based server that communicate with the smart device that further communicate with the product. The parent may set different notifications to the child's watch, for example but not limited to: “today grandma is coming, remember to come home early”. These notifications may be set as a one-time notification to a specific future date, or as returning notifications directed to a fixed day in the week. When the notification is operated, a general message may be seen on the screen, and the child may need to push a button to hear the full notification. Upon pressing the button, the watch displays the full notification on the screen, and a sound indicating a new notification may be played.

As mentioned above, in some embodiments, the product may be connected to a server via the smart device. In such embodiment, the smart device is configured to support internet connectivity that enables it to be updated and fetch data from a cloud based server in order to transfer the data as notifications to the product. The cloud may be consisted of a backend server that represents an endpoint for smart devices to access. The backend uses a database to store system information for example, different users' details, products sessions, and notifications. The backend may also use third party services like other cloud servers to fetch further information and enhance the notifications scheme, (e.g. connecting to Barcelona Football Club to fetch next matches fixtures in order to notify a user via the product about them on time. Additionally, the backend may use push notification services such as but not limited to APNs (Apple Push Notification Service (https://developer.apple.com/library/ios/documentation/NetworkingInternet/Conceptual/RemoteNotificationsPG/Chapters/ApplePushService.html), to notify smart devices with content on demand (for example, the backend powers on the smart device with new data, rather than the smart device initiates a connection by itself). That content may then be used to modify the notifications timing and contents that have already been transmitted into the product and stored in the product's memory.

In some embodiments, the notifications may come from remote smart devices either of the same user or of other user, through the internet and/or a cloud based server. For example, other users that may want to send another user a “happy birthday” message may send a blessing through the internet (via a server) to this user's birthday (a single time alert or a repeated alert on a yearly basis). When the birthday comes, the smart device of the user will sync all the saved birthday wishes from all the other users into the product, and thus, when the birthday comes, even if the product did not sync with the smart device for a couple of days, the product will still play the wishes in a sequence.

Such a remote notification may be useful for elderly population, which rarely uses smart devices for reminders. For example, a relative or a nursing practitioner may set reminders to a physical product positioned at their house such as a clock, which may be easier for them to operate, and sync the messages via the internet to a nearby smart device to dynamically transmit notifications into the clock. This relative for example, may set reminders to take specific medicines at certain times. The user of the clock may further press a button or any other output sensor, to indicate that the medicine was taken. The button press may be documented in the smart device, and may provide confirmation that the instructions of a specific notification were fulfilled, and further it may serve for statistics on the elderly medicament treatment.

The product is preferably operated by batteries, and thus, a strict energy management may be required in order to save energy and allow operation of the product for a longer time period. By having ability to be turned off between notification sessions the products is capable of saving energy and consequently to extend its operation time between battery changes or recharging. Thus, the product suitable for such dynamic system comprises a component configured to turn it on (“wake up”) at the time of the next notification, and once the notification was executed, the product returns to a “sleep” mode or turn itself off.

This mode of operation may require, in addition to the MCU with the communication module, memory unit and the output sensor, a time counter such as but not limited to a RTC module (Real Time Clock), to enable the product to “wake up” (power on) in a certain point in time, activate the notification and go to “sleep” (battery saving mode) again until the next notification should be activated. Thus, the notification system of the invention allows battery saving without damaging the alertness of the product.

In accordance with embodiments of the invention, the product is operated by a battery and thus, a strict energy management may be required in order to save energy and allow operation of the product for a longer time period. In such scenario, the product may include a component configured to “wake” (power up) the product at the time of the notification, and once the user has completed the use and/or the action related to the notification, the product turns itself off, or moves to a sleep mode (battery saving mode). This feature may save energy and allow a longer use for this kind of products without the need to recharge or replace the power supply. This embodiment may include, but not necessarily, in addition to the communication module, memory module and an output sensor, an RTC module ((Real Time Clock) or any other method or module configured to count time intervals in any unit of measures, which will power on the product in a certain point in time, activate the notification and power it off after the notification.

The RTC may further allow the product to “wake” itself in a specific date and/or monthly/yearly event. The timer also allows the product to enter into a “sleep mode”, for saving power between sessions. When the time of the pre-installed notification arrives, the timer is configured and operable to “wake up” the hardware and the pre-installed output instruction are being performed. The timer may further be programmed with an event, for example, to alert the user every predetermined time period, to connect the product to the smart device in order to update the latest information to the product.

The output events of the physical product may include, but not limited to, producing a sound, lighting lights of different colors, vibration, movements and so on. The operation may be general, such as a general alert to all kinds of events, or may further be event specific. For example, if the product is a toy, a meeting with player A may operate the sound: “Player A is waiting for you”, and a number of LEDs will blink in a unique way.

The product may include versatile output components, such as, but not limited to: LEDs, Buzzers, speakers, vibrator, screen, mechanical parts (in the example of the toy, eyes blinking or tale movement), and the like.

The data on the physical product may be updated every time the user connects to the app that is running on the smart device. When a timer is set according to the new data, a new alerts cycle starts. The smart device may further include a simple analytic system, which learns the behavior of the user, and creates an automatic sync with the smart device according to his daily routine. For example, if the smart device recognizes that all the last syncs with the app occurred after 8:00 PM, the smart device may set the product to awake on 8:00 PM and try to sync automatically. Thus, the user may not need to remember to manually sync the product with the smart device, and the sync will occur automatically.

The product may be a toy, such as a doll, plush toy, car, dollhouse, game board and the like. It may also be a furniture and/or accessory, such as an alarm clock, remote control, a ball, a tooth brash and the like. Another variation are accessories and other consumer electronics products, such as earphones, guitar amplifiers, audio systems and the like.

The product may be activated by one or more smart devices. The smart devices may further be connected to a server database. These connections are configured to create an indirect link between the product and the server, through the smart device, and the information saved on the product may be persisted in the product's database table in the server and will be used by the application to link user information to the user, device and product. This information will allow a flexible management of the notifications by assigning notification to, but not limited to, product of specific type, user at specific app session/predefined settings, user with multiple products, user at certain age and any combination of such criteria.

Upon updating the notification database, the server may be configured to identify smart devices that need to be notified, to update their linked products. The notifications from the server may be sent, for example but not limited to, as push notification to the smart device. Alternatively, when the smart device runs the application it will query the server for pending notifications. In turn, the smart device may send the notification to the peripheral product, thus allowing a dynamic update of the product from a far computer via the server through the user's smart device.

When the smart device has new notifications for the product it will cache them, and in the next time that the product connects to the application running on the smart device, the application will send the cached notifications to the product and the product will persist the notification in its Notification Table.

In accordance with non-limiting examples of the invention, each notification may be define by the duration of time that passed since the product has been disconnected from the smart device and/or a specific date and time in the future such as, but not limited to, a birthday, a holiday. The notification may also define a sequence that run once it is activated. The sequence may be configured to produce an output reaction on the product, for example to play a specific audio, to turn a LED on with a specific pattern, to vibrate the product and else.

In one embodiment, the product includes a countdown timer, and thus, when the product is disconnected from the smart device, it may start a countdown timer with the nearest notification timeout as a starting point for the counting. Once the countdown timer elapsed it wakes up the product. Additionally or alternatively, once a notification for the product to a specific date and time has been saved to the product's Notification Table, a real-time-clock is set in order to “wake up” the product at that specific time.

When the product is turned on (wakes up) it may check what the cause of the wake-up was, which may be a countdown timer, the RTC, the user or the smart device's sync. Depending on the cause, the product may start to perform the defined sequence of the notification which caused the product to be turned on.

The notifications on the server may be personally updated, according to specific requested definitions of the user, or spontaneous notifications from the providing company, such as a notification for a public holiday, pre-defined in the server. The notifications on the server may also be personalized to suite certain characteristics of the user, such as the user's country, language, local time, hobbies, level of complexity in a game and the like. For example, a user getting to level 10 in a certain game App, may get different notifications then a user an level 5. A user which shows interest in a certain football team may get notifications connected to the team's games schedule, and so on. Users may also turn off the notifications/modify them as they wish.

In accordance with another variation of the invention, the hardware may include sensors, which are used as a specific cue for the hardware to “wake up”. For example, the need to wake up with the rise of dawn may be, but not limited to, mediated by a light sensor, which wakes the product up exactly at the rise of dawn. The sensors may also be used in order to prevent notifications in unwanted times. In the above example, the light sensor may be used in order to prevent the toy from operating an alarm in the dark, therefore preventing it from operating in the middle of the night, even in situations when the toy is not synced with the server from some reason.

The product may also include in some variations other kinds of input sensors, such as buttons, accelerometer, gyro, piezoelectric sensors and a like. These components may add to the product functionality, such as: a button may be used in order to initiate a connection to the smart device (instead of a spontaneous connection).

Reference is now made to the figures:

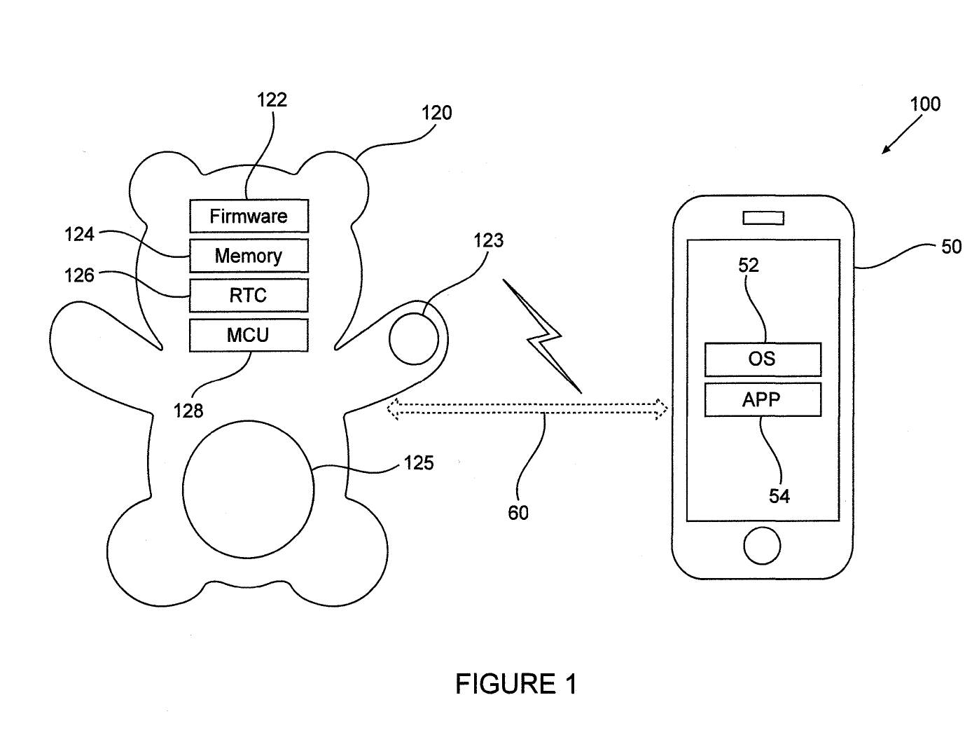

FIG. 1 is a schematic illustration of an example of a dynamic notification system 100 for transmission of notifications by a smart device 50 into a product 120 without wasting energy, wherein, the activation of the transmitted notifications may occur when the product is connected or unconnected to the smart device. Product 120 and smart device 50 may communicate with each other with any connectivity technology 60 suitable for wired or wireless connection as mentioned above. In order to allow the dynamic notification system 100 to function, the smart device 50 should be a programmable processing electronic device that uses an operating system 52 to run appropriate software application/s 54. Operating system 52 provides the software application/s with abilities such as connectivity 60 with the product and optionally with other products of the same user (not shown), background processing, turning the product on according to a pre-programmed time, and the like. The product 120 preferable comprises a firmware 122 (software layer that is embedded in the computer chip) that functionally controls and manages a memory unit 124, configured to store a notification table with timings and contents. The firmware 122 also uses a timer for counting time intervals, such as but not limited to a real time clock (RTC) 126 that configured and operable to enable product 120 to power on (wake up) on a pre-programmed time to execute a listed notification that was stored in the memory unit 124, while consuming minimum energy between the runs. The product 120 also comprises output components 123 such as LED light, speaker, motor for mechanical movement of the product or parts thereof, and the like, and may optionally comprise input sensors 125 including without limitation a microphone, motion sensors, thermometer, light sensors, and the like. These I/O components are used to execute the notifications' instructions and interact with the external world. For example, a notification can instruct the product 120 to turn on (wake) at a certain time point and play music with flashing lights. For executing this notification, a output components 123 such as a speaker and a LED may be used. In another optional embodiment, upon notification, the product 120 may be instructed to firstly measure the light that is captured by an input element 125 such as a light sensor, in order to determine if the aforementioned music sequence should or should not be played by the output components 123.

In some embodiments of the invention, the product may be configured to be operated by more than one smart device of the same user. The connection between the smart device and the product is established by a MCU 128 having a communication module integrated thereof. However, it should be clear that a MCU and a separated communication module may also be used in order to implement the subject matter disclosed herein and are considered to be within the scope of the invention.

In some other embodiments of the invention the smart device of a user may be configured to provide notifications to more than one product, wherein each product is identified by the software application of the smart device and obtains a unique notification list according to the type of product and its usage.

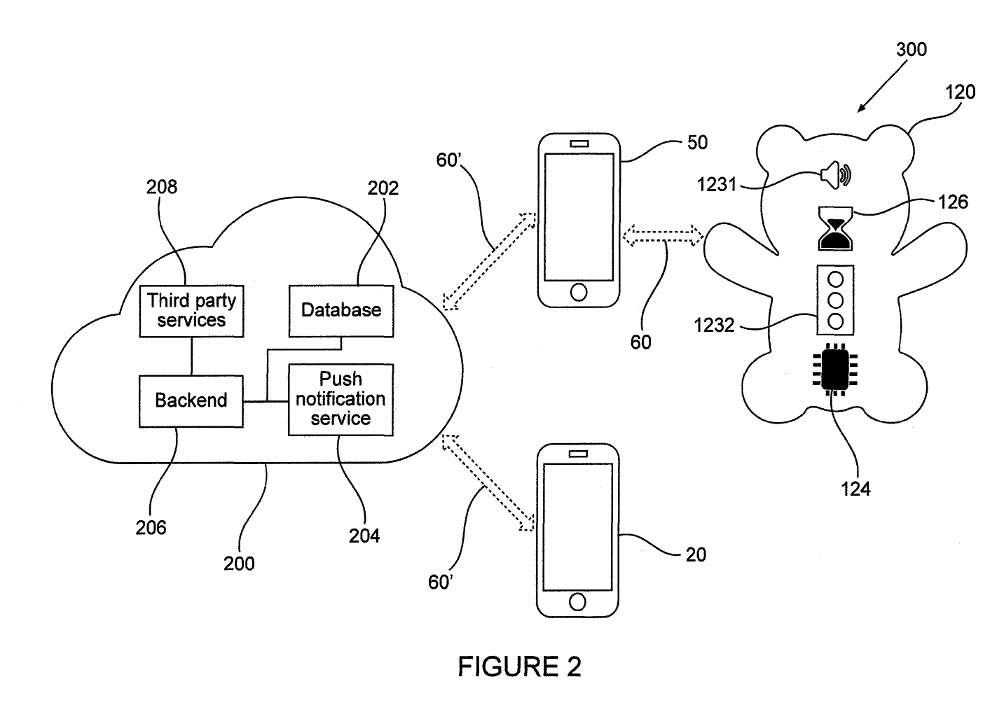

FIG. 2 is a schematic diagram of another example of a dynamic notification system 300 for dynamic transmission and activation of notifications from a server 200 into a product 120 via a smart device 50 without wasting energy. In the example illustrated in this figure more than one user can interact with products 120 via smart devices 20 and 50. The smart devices and the product are equipped with connectivity capability 60 that enables them to transfer data with each other. Smart devices 20 and 50 are further configured to support internet connectivity 60′ that enables them to update and fetch data from cloud 200. The cloud 200 contains at least a backend server 206 that represents an endpoint for smart devices to access. The backend server 206 uses a database 202 to store system information for example, the user's details, products sessions and notifications. The backend 206 also uses third party services 208 such as other cloud servers to fetch further information and enhance the notifications scheme delivered to the product/s, for example, connecting to Barcelona Football Club to fetch data about next matches in order to notify via product 120 the user of the product. Additionally, the backend server 206 may use push notification services 204 such as APNs (Apple Push Notification Service) to notify smart devices with content on demand (e.g. the backend turns on (“wakes”) the smart device with new data, rather than the smart device initiates a connection by itself). That content then can be used to modify and update the notifications timing and contents that were transmitted to the product.

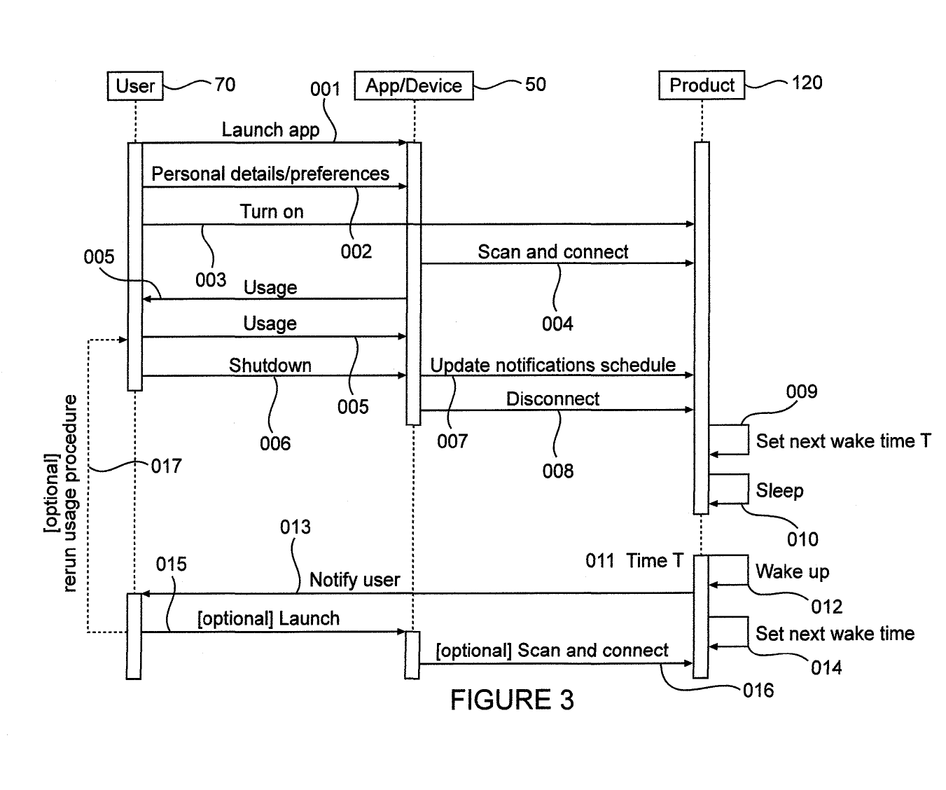

FIG. 3 is a sequence diagram illustrating a main use case of system 100 illustrated in FIG. 1, where a user 70 interacts with an application of a smart device 50 and a physical product 120 that is capable of turning off and turning on by itself to execute notification sequence in a pre-programmed schedule. User 70 launches (001) an application that is newly installed on a smart device 50. The user 70 then enters his preferences (002) that are usually used to enhance the notifications scheme (e.g. user's age, hobbies, time zone, and the like). This information can be entered as a part of the first use of the app but also at any other opportunity. The user 70 also turns on (003) the product 120, so that the app/device 50 can scan and establish a connection (004) with the product 120. The user 70 uses (005) the application on the smart device 50 according the relevant app use cases/play pattern. Upon end of usage, the user 70 shut down (006) the application and/or the smart device 50. Right before session ends, and if required (if anything was modified) the app/smart device 50 recreates the most updated notification schedule and sends it (007) to product 120. The app/smart device 50 then sends a disconnect signal (008) to end the established connection and allow all entities of the system (user 70, app/smart device 50 and product 120) to go in separate ways independently. After disconnection (008) the product 120 uses its embedded memory unit to store the next wake time T (009) and sets the real time clock to wake the product 120 on time T in the future. The product 120 goes to sleep mode (010) in which it consumes minimum energy. At any point of time T (011) the real time clock inside the product sends a power on (wake up) signal (012) to turn on the product 120 units and modules. The firmware of the product reads the pending notification to play and its instructions (input/output) from the embedded memory unit, and then executes the notification (013) to the user 70. The product 120 takes advantage of the awaken session (012) to set the real time clock for the next turn on (wake) time (014) that is next in the notifications table that is store on the memory unit of product 120. At this stage, it is optional that the executed notification (013) will make/require the user 70 to launch (015) the app on the smart device 50, which scans and connects (016) to the (already turned on) product 120 and to start a new usage procedure (like 005). If so, the system returns to the normal usage procedure (017) that is similar to the described above.

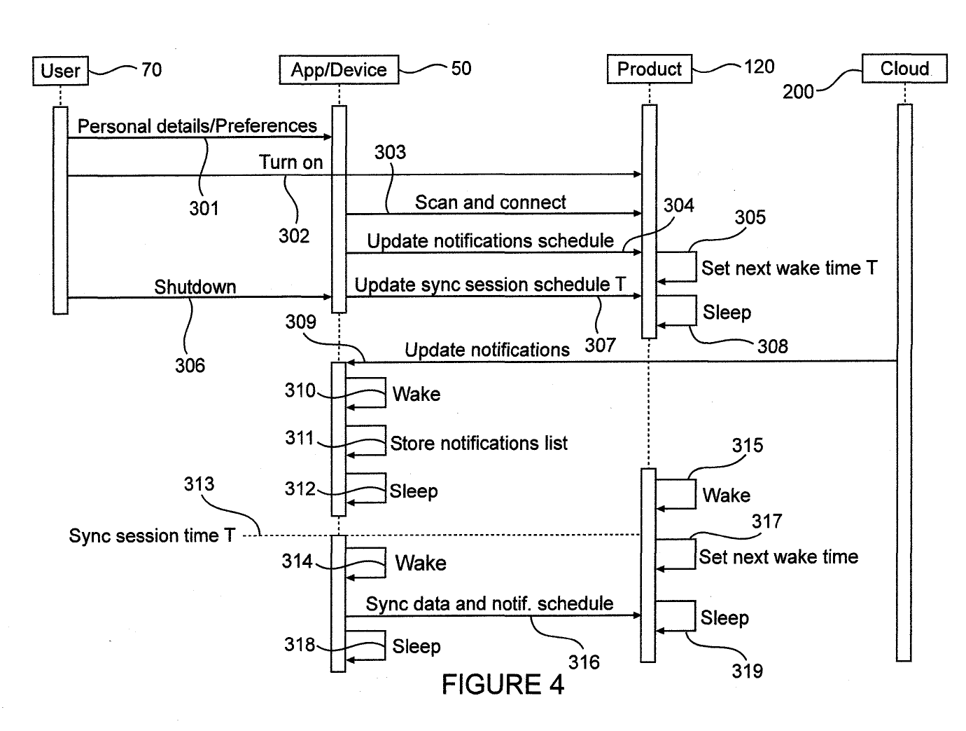

FIG. 4 is a sequence diagram illustrating another main use case of system 300 illustrated in FIG. 2, where the app/smart device 50 and the product 120 are turned on (wake) at a predetermined time in order to synchronize data. Cloud services 200 can also modify the notification composition by notifying the app/smart device 50 with new content.

Similar to the use case described with reference to FIG. 3 a user 70 uses the app/smart device 50 and enters his personal preferences (301). The user also manually turns on (302) product 120 that is now available for the app/smart device 50 to scan and connect (303) to it. Upon connection, the app/smart device 50 sends the product 120 the most updated notifications schedule (304), and the product 120 stores the updated notification schedule and immediately sets a time counter such as the real time clock to turn on (wake) the product's units and modules at the time of the next notification (305). In this use case the app/smart device 50 also updates the product 120 about the next schedule session on time T (307). At this time T, both the app/smart device 50 and the product 120 are programmed to wake up in order to transfer data and sync new notification updates. The product and app/smart device go in separate paths and a disconnection may be made (but not necessarily). Eventually the product 120 can enter into a sleep mode (308) and consume minimum energy.

Similar to common push notification procedure in mobile apps, at any time the cloud 200 can initiates a push notification to the app/smart device 50 and update it with content regarding notifications (309), for example an updated result of a football match of the user's favorite football club. Upon push notification from cloud 200 (for example via APNs), the app/smart device 50 is powered on (wakes up) (310) if it is not active, and stores the incoming notification list and content (311) optionally but not necessarily in a background process. The app/smart device may then return to the state it was before the notification arrived, e.g. sleep mode (312). When sync session time T comes (313), both, the product and the app/smart device are turned on (wake) (315, 314 respectively) to active mode. The product 120 and the app/smart device 50 exchange updated information (316) (e.g. new content that was provided by cloud 200, or new input sensor data that was collected by the product and “decide” the next wake time to sync. The product set the real time clock to wake him (317) on the next closest time (either a sync session or a normal notification execution). Next wake time will then be exploited to set the next closest time to wake after that (either a sync session or a normal notification execution) in the same way, and so on. The product and the app/smart device may go back to their former state, like sleep mode (319, 318 respectively).

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

1. A dynamic notification system configured to allow a product to send one or more notifications to a user in a dynamic and programmable manner, without having a constant connection to a smart device, and without being constantly in an operation mode, said system comprising:
a. a product configured to be synchronized with a smart device of said user for obtaining at least one notification to be executed by at least one output element comprised in said product, wherein said product is configured to power itself on at a time point a notification should be executed, and to turn itself off upon completing to execute said notification instructions until another notification time point arrives to be executed, so as to consume minimal energy between executions of subsequent notifications; and
b. a smart device comprising a dedicated software configured to allow recognition and connectivity of the smart device with said product so as to transmit notifications to said product to be executed according to a pre-defined manner.

2. The dynamic notification system according to claim 1, wherein said product comprises at least:
a. A firmware configured to control and manage a memory unit according to time intervals counted by a time counting module so as to allow said product to turn itself on at predefined time points and execute listed notifications that are stored in said memory unit;
b. A memory unit configured to allow storage of said notifications with timing and content;
c. A time counting module configured to count time intervals so as to allow the product to power on at a certain point in time, activate the notification and power itself off;
d. A micro control unit having a communication module configured to allow the product to synchronize with said smart device and to control the operation of at least one output element;
e. At least one output element configured to allow execution of said notifications instructions; and
f. A power source.

3. The dynamic notification system of claim 1, wherein said product is configured to be powered on and synchronized with said smart device in at least one of the following situations: (a) every predefined time period; (b) upon accumulation of a predefined number of new notifications in the smart device; (c) upon performance of manual synchronization of the product by the user.

4. The dynamic notification system of claim 1, wherein said output element is selected from the group consisting of LEDs, buzzers, speaker, mechanic elements and a screen.

5. The dynamic notification system of claim 1, wherein said product is capable of executing said notification's instructions saved in said memory unit while being connected or non-connected to the smart device.

6. The dynamic notification system of claim 1, wherein said notification is a repeated notification configured to be executed periodically by said product.

7. The dynamic notification system of claim 1, further comprising an input element configure to allow a user to follow instructions of a notification so as to provide the product an input for activating an output reaction by the product.

8. The dynamic notification system of claim 1, wherein said smart device is further connected to a cloud server.

9. The dynamic notification system according to claim 8, wherein said connection to said cloud server further allows said smart device to deliver to said product at least one notification obtained from a smart device of another user.

10. The dynamic notification system according to claim 8, wherein said connection to said cloud server further allows a user to send notification to said product from a remote location by using additional smart device of said user.

11. The dynamic notification system of claim 1, wherein said smart device is selected from the consisting: smart phone, tablet, phablet, smart television, laptop, smart wearable device, and personal computer.

12. The dynamic notification system of claim 1, wherein said notification is a set of actions that are being executed by said product in a sequence according to the predefined instructions received from the smart device by one or more output elements.

13. A product to send one or more notifications to a user in a dynamic and programmable manner, the product comprising: a product configured to be synchronized with the internet, a cloud based server, or a smart device of a user for obtaining at least one notification to be executed by at least one output element comprised in said product, wherein said product is configured to power itself on at a time point a notification should be executed, and to turn itself off upon completing to execute said notification instructions until another notification time point arrives to be executed, so as to consume minimal energy between executions of subsequent notifications.

14. The product according to claim 13, said product further comprising:
a. A firmware configured to control and manage a memory unit according to time intervals counted by a clock module so as to allow said product to turn itself on at predefined time points and execute listed notifications that are stored in said memory unit;
b. A memory unit configured to allow storage of said notifications with timing and content;
c. A time counting module configured to count time intervals so as to allow the product to power on at a certain point in time, activate the notification and power itself off;
d. A micro control unit having a communication module configured to allow the product to synchronize with said smart device and to control the operation of at least one output element;
e. At least one output element configured to allow execution of said notifications instructions; and
f. A power source.

15. The product of claim 13, wherein said product is configured to be powered on and synchronized with said smart device in at least one of the following situations: (a) every predefined time period; (b) upon accumulation of a predefined number of new notifications in the smart device; (c) upon performance of manual synchronization of the product by the user.

16. The product of claim 13, wherein said product is capable of executing said notification's instructions saved in said memory unit while being connected or non-connected to the smart device.

17. The product of claim 13, wherein said notification is a repeated notification configured to be executed periodically by said product.

18. The product of claim 13, wherein said notification is a set of actions that are being executed by said product in a sequence according to the predefined instructions received from the smart device by one or more output elements.

19. The product of claim 13, further comprising an input element configure to allow a user to follow instructions of a notification so as to provide the product an input for activating an output reaction by the device.

20. The product of claim 13, further comprising an input element configured to allow a manual or automatic monitoring on the timing of the notification, delay it or prevent it.
